(19) United States
(12) Patent Application Publication
(10) Pub. No.: US 2009/0280225 A1
(43) Pub. Date: Nov. 12, 2009

(54) Process of Making Puff Pastry

(76) Inventor: Nataliya Volodimirovna Belikova, Kharkiv (UA)

Correspondence Address: Aleksandr Smushkovich, POB 140505, Brooklyn, NY, 11214, US

(21) Appl. No.: 11/887,997

(22) PCT Filed: Apr. 6, 2006
(86) PCT No.: PCT/UA2006/000017

§ 371 Date: Oct. 5, 2007

(30) Foreign Application Priority Data
Apr. 18, 2005 (UA) U 2005 03596

(51) Int. Cl. A21D 13/08

(52) U.S. Cl. 426/275

(57) ABSTRACT

The inventive process relates to making flour confectionery products, namely, puff pastry, and comprises: preparation of dough with certain humidity by mixing flour, water, citric acid, and egg products, maturing the dough for swelling of gluten, forming the dough by rolling it out in several stages, applying at the last stage a cover layer with filler having thickness not exceeding 2 mm, sandwiching the dough with soft-fat component, multiple rolling and cooling the dough in several stages, forming dough pieces, covering each piece with the cover layer, baking the dough at a temperature of 240° C., the humidity of the dough is maintained within the range of 22-27%. The filler may have different bases: grated cheese, salt, spices, mushrooms, nuts, invert liquid sugar with spices or dried fruits or poppy-seeds or sesame, or combinations thereof. The resultant products have high organoleptic qualities and preserve their consumer qualities within a long time period.

### CROSS-REFERENCE TO RELATED APPLICATIONS

This application is a U.S. national phase application of a PCT application PCT/UA2006/000017 filed on 6 Apr. 2006, published as WO2006/112804, whose disclosure is incorporated herein in its entirety by reference which PCT application claims priority of a Ukrainian patent application UA200503596 filed on 18 Apr. 2005.

### FIELD OF THE INVENTION

The invention relates to the food industry, in particular to the confectionary industry, and is dedicated to a technology of making flour confectionery products, such as puff pastry.

### BACKGROUND OF THE INVENTION

It is known the technology of making flour confectionery products of roll-in dough, where a half-finished product is made of the elastic-plastic roll-in dough by mixing flour, mélange, salt, acid and water, followed by rolling of the pre-prepared fat component into it. In the course of making the dough, the latter is repeatedly cooled under a temperature of 5-10° C. within 30-40 minutes. The dough's humidity is maintained within the ranges of 41-44%. The dough pieces are coated by a thin layer of sanding sugar. The baking is made under a temperature ranging from 215 to 250° C. within 25-30 minutes.

The product made of this dough has typical flakiness that is achieved due to the use of a raw material, which meets certain requirements, multiple folding and rolling of the dough layers and presence of a fat layer between the dough layers. Such confectionery as pastries and cakes are typically made of such dough. The products usually have a humidity of about 10-12% after the baking and about 4-6% after the drying. The thickness of a half-finished dough piece is usually about 4.5-10 mm and it becomes several times thicker after the baking. The storage time of the baked product is not long, as during storage the product absorbs moisture and becomes not crispy. This reduces its consumer qualities.

It is known a technology of making flour confectionery products of roll-in dough called “Berliner puff pastry”. According to that technology, the dough is made by mixing first-class wheat flour, water and citric acid, which are taken in amounts that provide a humidity within the range of 41-44%. The dough is matured for 28-30 minutes for swelling of gluten, then it is rolled out and sandwiched with soft margarine by multiple folding, rolling the dough and cooling thereof. As a result of this process a fat layer is created between the dough layers. Thereafter, the dough pieces are formed and baked under a temperature of 230° C.-240° C. Then the dough layers are placed upon one another, and the product is also simultaneously sandwiched with fruit jam. The typical storage time of the baked product is seven days.

The closest process to the inventive solution is a process of making puff pastry that includes preparation of dough with certain humidity by mixing flour, water, citric acid, egg products; maturing the dough for swelling of gluten; forming the dough by rolling it out and sandwiching it with a soft fat component; multiple folding; rolling and cooling the dough in several stages; forming a dough piece, covering it with a cover and baking it. During this process the kneaded dough must mature for 30 minutes. The dough's humidity must be within the range of 41-44%.

The cooling is made under a temperature of 12-14° C. at least within 30 minutes. The dough layer is rolled out up to a thickness of 5 mm at the last stage. The dough piece is covered by egg and sugar powder before baking. The baking is made under the temperature of 210-230° C. During the baking process the size of the product increases 2-3 times. The product has a humidity of 10-12% after the baking and 4-6% after the drying. However, the storage time of the baked product is not longer than seven days. After the expiration of this period the flakiness and crispness of the product are getting lower that worsens the organoleptic qualities of the finished product.

Similar technologies and techniques are described in Taleysnik M. A., Aksenova L. M., Bernstein T. C. <<Technology of making flour confectionery goods>>, Moscow, Agropromizdat, 1986, p. 55-58; Buteyknis N. G., Kengis R. P., flour confectionery goods>>. Moscow, <<Ekonomika>>, 1969, p. 161-170: and Patent of Russian Federation No. 2245049.

### BRIEF DESCRIPTION OF THE INVENTION

The invention is therefore dedicated to solving the mentioned problem of short storage time, and developing a process of making puff pastry, wherein the storage time of the finished product is extended and organoleptic qualities of the pastry are improved, that is achieved through a refinement process. The inventive process includes the preparation of dough with certain humidity by mixing flour, water, citric acid, egg products; maturing the dough for swelling of gluten; forming the dough by rolling it out and sandwiching it with the soft fat component; multiple folding, rolling and cooling the dough in several stages; forming a dough piece; covering it with a cover; baking it, according to the invention maintaining the humidity of the prepared dough within the range of 22-27%, rolling out the dough layer to a thickness not exceeding 2 mm, and applying a cover layer with filler.

In a further embodiment of the inventive process, the cover layer with filler is based on grated cheese and salt. In a further embodiment, the cover layer with filler is based on grated cheese, salt and spices. In a further embodiment, the cover layer with filler is based on grated cheese, salt and mushrooms. In a further embodiment, the cover layer with filler is based on grated cheese, salt and nuts. In a further embodiment, the cover layer with filler is based on invert liquid sugar and spices. In a further embodiment, the cover layer with filler is based on invert liquid sugar and dried fruits. In a further embodiment, the cover layer with filler is based on invert liquid sugar and poppy-seeds. In a further embodiment, the cover layer with filler is based on invert liquid sugar and sesame.

It is known that, for making puff pastry, the elastic-plastic rolled-in dough is used, which is made of flour, egg products (eggs and mélange), salt, citric acid and water. The raw materials with certain qualities are typically used in order to provide necessary flakiness and crispness of the product. For example, the flour that contains much gluten is used for kneading the dough.

The main role in making the dough, having its inherent characteristics (such as elasticity, plasticity, and viscosity), belongs to the proteins of flour. Water-insoluble proteins of flour, which form gluten (gliadin and glutenin), bind water in dough in adsorptive and osmotic way. Osmotic swelling happens as a result of diffusion of a water molecule inside a flour protein molecule. As a result of the osmotic binding of water and swelling of flour proteins during the dough kneading, a spongy-like structure is created, which substantially determines specific characteristics of the dough, such as its stretchability and elasticity.

The use of acid increases the swelling ability and viscosity of flower gluten proteins and thereby helps producing the dough with the optimal characteristics. Fat components added to the dough reduce the flower proteins swelling ability and facilitate the reduction of elasticity and increase of plasticity of the dough. The layers of the fat component between flower particles facilitate the creation of porous structure and crispness of the finished products. The fat component is rubbed into the dough in a soft form.

It is known that the optimal temperature of the soft fat component must be within the temperature range of 12-14° C. In order to produce the product of high quality the prepared dough and the fat component must have a substantially equal consistence.

Sandwiching the dough with the fat component followed by rolling and cooling processes is made in several stages. As a result of these processes the dough is made with multiple fat layers. The humidity of the finished dough amounts to 22-27%. At a last stage, the humidity of the finished dough allows rolling out the layers, which are no more than 2 mm thick. This provides the minimum humidity of the baked product, that greatly extends its storage time not affecting its crispiness and this also increases the consumer and organoleptic qualities of the product.

Furthermore, the applying of a cover layer with filler on the dough piece before its baking, essentially influences the organoleptic qualities of the finished product. Moreover, the cover layer may have different base and taste that adds some new organoleptic qualities to the product. Different additive means may be added into the filler. Exemplarily, the cover layer with filler based on grated cheese and salt, or on grated cheese, salt and spices, or on grated cheese, salt and mushrooms, or on grated cheese, salt and nuts, substantially provides the product with some salty flavor. The cover layer with filler based on invert liquid sugar and spices, or on invert liquid sugar and dried fruits, or on invert liquid sugar and poppy-seeds, or on invert liquid sugar and sesame, introduces some sweet flavor to the product.

Thusly, the inventive process of making puff pastry results in obtaining new flour confectionery products, which have new organoleptic qualities, extended storage time, without reduction of its consumer qualities.

### DESCRIPTION OF PREFERRED EMBODIMENTS OF THE INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as exemplified herein.

Preferred embodiments of the inventive process of making puff pastry are implemented as disclosed in the following examples.

### EXAMPLE 1

Flour, water, eggs, citric acid and salt are put into a container and thoroughly stirred forming dough. The humidity of the prepared dough must be within the range of 22-27%. Then the dough is matured for swelling of gluten within 20 minutes. Thereafter, the dough is rolled out, some soft margarine is put on the dough layer; after that the dough is folded in the form of an envelope. The dough is rolled out again substantially to a thickness of 10 mm. The dough layer is folded, rolled out and folded again. Then the dough is cooled within 20 minutes. Next, the dough is rolled out, folded, rolled out and folded again, and then it is cooled within 20 minutes. Thereafter, the dough is rolled out to a thickness of no more than 2 mm. Next, a dough piece is formed. For this purpose the dough layer is cut into small polygon pieces. An egg cover layer is applied on the dough pieces and then they are sprinkled with grated cheese mixed with red pepper and salt. The products are then baked under a temperature substantially of 240° C. Lastly, the finished flour confectionery products are cooled.

### EXAMPLE 2

Flour, water, eggs, citric acid and salt are put into a container and thoroughly stirred to produce dough. The humidity of the prepared dough must be within the range of 22-27%. Then the dough is matured for swelling of gluten within 20 minutes. Thereafter, the dough is rolled out, some soft margarine is put on the dough layer; after that the dough is folded in the form of an envelope. Next, the dough is rolled out again substantially to a 10 mm thickness. The so obtained dough layer is folded, rolled out and folded again. Then the dough is cooled within 30 minutes. Thereafter, the dough is rolled out, folded, rolled out and folded again, and then it is cooled within 30 minutes. Next, the dough layer is rolled out to a thickness not exceeding 2 mm. After that dough pieces are formed. For this purpose the dough layer is cut into small polygon pieces. An egg cover layer is applied onto the dough pieces and then they are sprinkled with grated cheese mixed with caraway seeds and salt. Thereafter, the pieces are baked under a temperature of substantially 240° C. The finished flour confectionery products are cooled.

### EXAMPLE 3

Flour, water, eggs, citric acid and salt are put into a container and thoroughly stirred. The humidity of the prepared dough must be within the ranges of 22-27%. Then the dough is matured for swelling of gluten within 20 minutes. Next, the dough is rolled out, some soft margarine is put on the dough layer; after that the dough is folded in the form of an envelope. The dough is then rolled out again to 10 mm thickness. The dough layer is folded, rolled out and folded again. Next, the dough is cooled within 20 minutes. Thereafter, the dough is rolled out, folded, rolled out and folded again, and then it is cooled within 20 minutes. Next, the dough is rolled out to a thickness not exceeding 2 mm. After that dough pieces are formed. For this purpose the dough layer is cut into small polygon pieces. An egg cover layer is applied onto the dough pieces and then they are sprinkled with grated cheese mixed with dried grinded mushrooms and salt. Thereafter, the pieces are baked under a temperature of substantially 240° C. The finished flour confectionery products are cooled.

### EXAMPLE 4

Flour, water, eggs, citric acid and salt are put into a container and thoroughly stirred. The humidity of the prepared dough must be within the range of 22-27%. Then the dough is matured for swelling of gluten within 20 minutes. Thereafter, the dough is rolled out, some soft margarine is put on the dough layer; after that the dough is folded in the form of an envelope. The dough is rolled out again to 10 mm thickness. The so obtained dough layer is folded, rolled out and folded again. Next, the dough is cooled within 25 minutes. Thereafter, the dough is rolled out, folded, rolled out and folded again, and then it is cooled within 25 minutes. Then the dough is rolled out to a thickness not exceeding 2 mm. After that dough pieces are formed. For this purpose the dough layer is cut into small polygon pieces. An egg cover layer is applied onto the dough pieces and then they are sprinkled with grated cheese mixed with grinded nuts and salt. Next, the products are baked under a temperature of substantially 240° C. The finished flour confectionery products are cooled.

### EXAMPLE 5

Flour, water, eggs, citric acid and salt are put into a container and thoroughly stirred. The humidity of the prepared dough must be within the range of 22-27%. Then the dough is matured for swelling of gluten within 20 minutes. Next, the dough is rolled out, some soft margarine is put on the dough layer; after that the dough is folded in the form of an envelope. The dough is then rolled out again into a layer with a thickness substantially of 10 mm. The dough layer is folded, rolled out and folded again. Next, the dough is cooled within 20 minutes. Thereafter, the dough is rolled out, folded, rolled out and folded again, and then it is cooled within 20 minutes. Next, the dough is rolled out into a layer with thickness not exceeding 2 mm. After that dough pieces are formed. For this purpose the dough layer is cut into small polygon pieces. An egg cover layer is applied onto the dough pieces and then they are covered with invert liquid sugar and sprinkled with poppy-seeds. Thereafter, the pieces are baked under a temperature of substantially 240° C. The finished flour confectionery products are cooled.

### EXAMPLE 6

Flour, water, eggs, citric acid and salt are put into a container and thoroughly stirred. The humidity of the prepared dough must be within the range of 22-27%. Then the dough is matured for swelling of gluten within 20 minutes. Next, the dough is rolled out, some soft margarine is put on the dough layer; after that the dough is folded in the form of an envelope. The dough is rolled out again to a layer with a thickness of substantially 10 mm. The dough layer is then folded, rolled out and folded again. Next, the dough is cooled within 25 minutes. Thereafter, the dough is rolled out, folded, rolled out and folded again, and then it is cooled within 25 minutes. Next, the dough is rolled out to a layer with a thickness not exceeding 2 mm. After that dough pieces are formed. For this purpose the dough layer is cut into small polygon pieces. An egg cover layer is applied on the dough pieces and then they are covered with invert liquid sugar and sprinkled with sesame. Thereafter, the pieces are baked under a temperature of substantially 240° C. The finished flour confectionery products are cooled.

### EXAMPLE 7

Flour, water, eggs, citric acid and salt are put into a container and thoroughly stirred. The humidity of the prepared dough must be within the range of 22-27%. Then the dough is matured for swelling of gluten within 20 minutes. Next, the dough is rolled out, some soft margarine is put on the dough layer; after that the dough is folded in the form of an envelope. The dough is rolled out again into a layer with a thickness of substantially 10 mm. The dough layer is folded, rolled out and folded again. Thereafter, the dough is cooled within 20 minutes. Next, the dough is rolled out, folded, rolled out and folded again, and then it is cooled within 20 minutes. Then the dough is rolled out into a layer with a thickness not exceeding 2 mm. After that dough pieces are formed. For this purpose the dough layer is cut into small polygon pieces. An egg cover is applied on the dough pieces and then they are covered with invert liquid sugar and sprinkled with grinded dried pitted and halved apricots. Thereafter, the pieces are baked under a temperature of substantially 240° C. The finished flour confectionery products are cooled.

### EXAMPLE 8

Flour, water, eggs, citric acid and salt are put into a container and thoroughly stirred. The humidity of the prepared dough must be within the range of 22-27%. Then the dough is matured for swelling of gluten within 20 minutes. Thereafter the dough is rolled out, some soft margarine is put on the dough layer; after that the dough is folded in the form of an envelope. The dough is rolled out again into a layer with a thickness of substantially 10 mm. The dough layer is folded, rolled out and folded again. Next, the dough is cooled within 20 minutes. Thereafter, the dough is rolled out, folded, rolled out and folded again, and then it is cooled within 20 minutes. Next, the dough is rolled out to a layer with a thickness not exceeding 2 mm. After that dough pieces are formed. For this purpose the dough layer is cut into small polygon pieces. An egg cover layer is applied on the dough pieces and then they are covered with invert liquid sugar and sprinkled with ginger. Thereafter, the pieces are baked under a temperature of substantially 240° C. The finished flour confectionery products are cooled.

The flour confectionery products resulted in the above examples have high organoleptic and consumer qualities and may preserve these qualities within a long period of time.

1-9. (canceled)

10. A process of making puff pastries, comprising the steps of:
preparation of dough with predetermined humidity by mixing flour, water, citric acid, and egg products;
maturing said dough for swelling of gluten;
forming said dough by rolling it out;
sandwiching said dough with a soft fat component;
multiple rolling said dough into layers in several stages and cooling said dough, the last stage being characterized in that the thickness of the layers not exceeding 2 mm;
forming dough pieces;
applying a cover layer with filler onto the dough pieces; and
baking the dough pieces thereby producing said puff pastries;
wherein a humidity of said dough being maintained within the range of from 22% to 27%, and a resultant humidity of the puff pastries after said baking being at a minimum level.

11. The process according to claim 1, wherein said filler being prepared based on grated cheese and salt.

12. The process according to claim 1, wherein said filler being prepared based on grated cheese, salt, and spices.

13. The process according to claim 1, wherein said filler being prepared based on grated cheese, salt, and mushrooms.

14. The process according to claim 1, wherein said filler being prepared based on grated cheese, salt, and nuts.

15. The process according to claim 1, wherein said filler being prepared based on invert liquid sugar and spices.

16. The process according to claim 1, wherein said filler being prepared based on invert liquid sugar and dried fruits.

17. The process according to claim 1, wherein said filler being prepared based on invert liquid sugar and poppy-seeds.

18. The process according to claim 1, wherein said filler being prepared based on invert liquid sugar and sesame.

19. The process according to claim 1, wherein said baking provided under a temperature substantially of 240° C.

20. A process of making puff pastries, comprising the steps of:
preparation of dough with predetermined humidity by mixing flour, water, citric acid, and egg products;
maturing said dough for swelling of gluten;
forming said dough by rolling it out;
sandwiching said dough with a soft fat component;
multiple rolling said dough into layers in several stages and cooling said dough, the last stage being characterized in that the thickness of the layers not exceeding 2 mm;
forming dough pieces;
applying a cover layer with filler additive means onto the dough pieces; and
baking the dough pieces under a temperature substantially of 240° C.;
wherein a humidity of said dough being maintained within the range of from 22% to 27%, and a resultant humidity of the puff pastries after said baking being at a minimum level.
